(19) United States
(12) Patent Application Publication
(10) Pub. No.: US 2024/0098725 A1
(43) Pub. Date: Mar. 21, 2024

(54) SYSTEMS AND METHODS FOR MANAGING FREQUENCY RESOURCE GROUP BASED SERVICE TRANSMISSIONS

(71) Applicant: ZTE Corporation, Shenzhen (CN)

(72) Inventors: Xing Liu, Shenzhen (CN); Peng Hao, Shenzhen (CN); Xingguang Wei, Shenzhen (CN); Shuaihua Kou, Shenzhen (CN)

(21) Appl. No.: 18/522,099

(22) Filed: Nov. 28, 2023

Related U.S. Application Data
(63) Continuation of application No. PCT/CN2021/136800, filed on Dec. 9, 2021.

(51) Int. Cl. H04W 72/0453

(52) U.S. Cl. CPC H04W 72/0453

(57) ABSTRACT

Example implementations include receiving, by a wireless communication device from a network, first signaling identifying a frequency resource set, receiving, by the wireless communication device from the network, second signaling identifying two or more frequency resources from the frequency resource set to be activated simultaneously. The two or more frequency resources comprises a first frequency resource and a second frequency resource. In response to receiving the second signaling, the wireless communication device communicates with the network using the two or more frequency resources simultaneously.

### CROSS-REFERENCE TO RELATED APPLICATIONS

This application is a continuation and claims priority to International Application No. PCT/CN2021/136800, filed on Dec. 9, 2021, the disclosure of which is hereby incorporated by reference herein in its entirety. This application relates to Attorney Docket No. ZTE-2021-002260-WO, titled “SYSTEMS AND METHODS FOR MANAGING FREQUENCY RESOURCE GROUP BASED SERVICE TRANSMISSIONS,” filed on Dec. 9, 2021, the disclosure of which is incorporated herein by reference in its entirety. This application also relates to Attorney Docket No. ZTE-2021-002275-WO, titled “SYSTEMS AND METHODS FOR MANAGING FREQUENCY RESOURCE GROUP BASED SERVICE TRANSMISSIONS,” filed on Dec. 9, 2021, the disclosure of which is incorporated herein by reference in its entirety. This application further relates to Attorney Docket No. ZTE-2021-002282-WO, titled “SYSTEMS AND METHODS FOR MANAGING FREQUENCY RESOURCE GROUP BASED SERVICE TRANSMISSIONS,” filed on Dec. 9, 2021, the disclosure of which is incorporated herein by reference in its entirety.

### TECHNICAL FIELD

The present implementations relate generally to wireless communications, and more particularly to systems, methods, apparatuses, and non-transitory computer-readable media for managing frequency resource group based service transmissions.

### BACKGROUND

Currently, the first phase standardization of the 5th Generation mobile communication technology (5G) has already completed. A series of unicast and multicast features had been specified in the first three New Radio (NR) releases, Rel-15, Rel-16 and Rel-17. Future releases relate to receiving multiple transmission services at the same time.

### SUMMARY

In some arrangements, a wireless communication device receives from a network first signaling identifying a frequency resource set and second signaling identifying two or more frequency resources from the frequency resource set to be activated simultaneously. The two or more frequency resources includes a first frequency resource and a second frequency resource. In response to receiving the second signaling, the wireless communication device communicates with the network using the two or more frequency resources simultaneously.

In some arrangements, the network sends to the wireless communication device first signaling identifying a frequency resource set and second signaling identifying two or more frequency resources from the frequency resource set to be activated simultaneously. The two or more frequency resources includes a first frequency resource and a second frequency resource. In response to sending the second signaling, the network communicates with the wireless communication device using the two or more frequency resources simultaneously.

The above and other aspects and their implementations are described in greater detail in the drawings, the descriptions, and the claims.

### BRIEF DESCRIPTION OF THE DRAWINGS

These and other aspects and features of the present implementations is apparent to those ordinarily skilled in the art upon review of the following description of specific implementations in conjunction with the accompanying figures, wherein:

FIG. 1 is a diagram illustrating an example wireless communication network, according to various arrangements.

FIG. 2 is a diagram illustrating a block diagram of an example wireless communication system for transmitting and receiving downlink and uplink communication signals, according to various arrangements.

FIG. 3 is a diagram illustrating the manner in which different frequency ranges (e.g., first frequency range and second frequency range) within a carrier are configured with different downlink uplink frame structures, according to various arrangements.

FIG. 4 is a table illustrating an example of configured relationships between Bandwidth Part (BWP) sets and BWPs of a cell, according to various arrangements.

FIG. 5 is a table illustrating an example of configured relationships between BWP sets and BWPs of a cell, according to various arrangements.

FIG. 6 is a diagram illustrating an example of configured relationships between BWP sets and BWPs of a cell according to various arrangements.

FIG. 7 is a diagram illustrating an example of configured relationships between BWP sets and BWPs of a cell, according to various arrangements.

FIG. 8 is a diagram illustrating an example of configured relationships between BWP sets and BWPs of a cell, according to various arrangements.

FIG. 9 is a diagram illustrating an example of configured relationships between BWP sets and BWPs of a cell, according to various arrangements.

FIG. 10 is a diagram illustrating an example of configured relationships between BWP sets and BWPs of a cell, according to various arrangements.

FIG. 11 is a diagram illustrating timer-based BWP group switching, according to various arrangements.

FIG. 12 is a diagram illustrating timer-based BWP group switching, according to various arrangements.

FIG. 13 is a diagram illustrating timer-based BWP group switching, according to various arrangements.

FIG. 14 is a flowchart diagram illustrating an example method for managing frequency resource group based service transmissions, according to various arrangements.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations is described, and detailed descriptions of other portions of such known components is omitted so as not to obscure the present implementations. Implementations described as being implemented in software should not be limited thereto, but can include implementations implemented in hardware, or combinations of software and hardware, and vice-versa, as is apparent to those skilled in the art, unless otherwise specified herein. In the present specification, an implementation showing a singular component should not be considered limiting. Rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

In some arrangements, a User Equipment (UE) may receive Multicast Broadcast Services (MBSs) and unicast services may receive simultaneously in a cell. Under full duplex or flexible duplex, a UE is can receive and transmit signals simultaneously or switch between reception and transmission without delay. In multi-band-one-cell/carrier settings, a UE receive or send signals in different bands/carriers which belong to a single cell. In these scenarios, multiple services need to be transmitted in parallel in the same cell. to the present arrangements relate to systems, methods, apparatuses, and non-transitory processor-readable media for coordinating or configuring concurrent services.

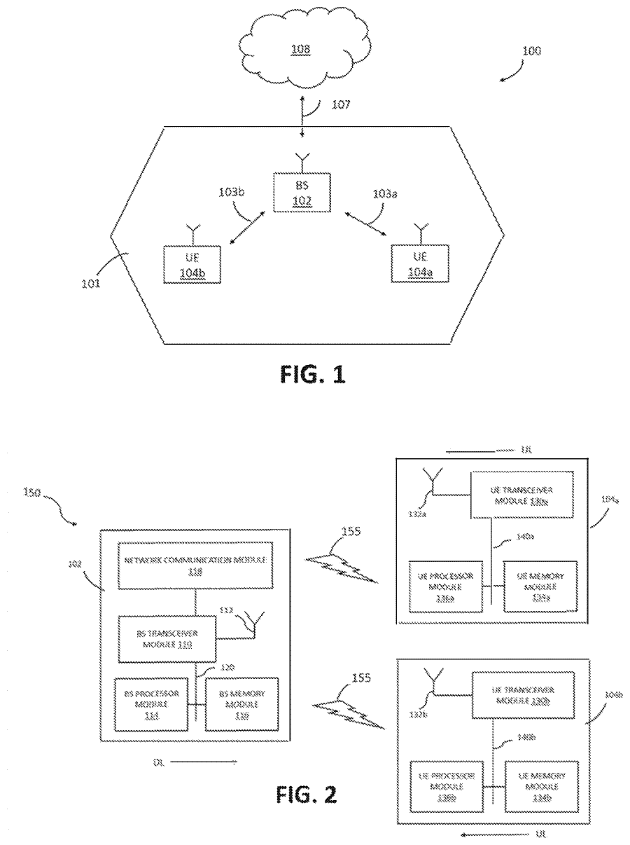

FIG. 1 shows an example wireless communication network 100. The wireless communication network 100 corresponds to a group communication within a cellular network. In the wireless communication network 100, a network-side communication node or a base station (BS) can include one or more of a next Generation Node B (gNB), an E-Utran Node B (also known as Evolved Node B, eNodeB or eNB), a pico station, a femto station, a Transmission/Reception Point (TRP), an Access Point (AP), or the like. A terminal-side node or a UE can include a long range communication system (such as but not limited to, a mobile device, a smart phone, a Personal Digital Assistant (PDA), a tablet, a laptop computer) or a short range communication system (such as but not limited to, a wearable device, a vehicle with a vehicular communication system, or the like). As in FIG. 1, a network-side communication node is represented by a BS 102, and a terminal-side communication node is represented by a UE 104a or 104b. In some arrangements, the BS 102 is sometimes referred to as a “wireless communication node,” and the UE 104a/104b is sometimes referred to as a “wireless communication device.”

As shown in FIG. 1, the BS 102 can provide wireless communication services to the UEs 104a and 104b within a cell 101. The UE 104a can communicate with the BS 102 via a communication channel 103a. Similarly, the UE 104b can communicate with the BS 102 via a communication channel 103b. The communication channels (e.g., 103a and 103b) can be through interfaces such as but not limited to, an Uu interface which is also known as Universal Mobile Telecommunication System (UMTS) air interface. The BS 102 is connected to a Core Network (CN) 108 through an external interface 107, e.g., an Iu interface.

FIG. 2 illustrates a block diagram of an example wireless communication system 150 for transmitting and receiving downlink and uplink communication signals, in accordance with some arrangements of the present disclosure. Referring to FIGS. 1 and 2, the system 150 is a portion of the network 100. In the system 150, data symbols can be transmitted and received in a wireless communication environment such as the wireless communication network 100 of FIG. 1.

The system 150 generally includes the BS 102 and UEs 104a and 104b. The BS 102 includes a BS transceiver module 110, a BS antenna 112, a BS memory module 116, a BS processor module 114, and a network communication module 118. The modules/components are coupled and interconnected with one another as needed via a data communication bus 120. The UE 104a includes a UE transceiver module 130a, a UE antenna 132a, a UE memory module 134a, and a UE processor module 136a. The modules/components are coupled and interconnected with one another as needed via a data communication bus 140a. Similarly, the UE 104b includes a UE transceiver module 130b, a UE antenna 132b, a UE memory module 134b, and a UE processor module 136b. The modules/components are coupled and interconnected with one another as needed via a data communication bus 140b. The BS 102 communicates with the UEs 104a and 104b via communication channels 155, which can be any wireless channel or other medium known in the art suitable for transmission of data as described herein.

The system 150 can further include any number of modules/elements other than the modules/elements shown in FIG. 2. The various illustrative blocks, modules, elements, circuits, and processing logic described in connection with the arrangements disclosed herein can be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionalities. Whether such functionalities are implemented as hardware, firmware, or software depends upon the particular application and design constraints imposed on the overall system. Those familiar with the concepts described herein may implement such functionalities in a suitable manner for each particular application, but such implementation decisions should not be interpreted as limiting the scope of the present disclosure.

A wireless transmission from an antenna of each of the UEs 104a and 104b to an antenna of the BS 102 is known as an uplink transmission, and a wireless transmission from an antenna of the BS 102 to an antenna of each of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter circuitry and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter circuitry and receiver circuitry that are each coupled to the antenna 112. A downlink duplex switch may alternatively couple the downlink transmitter or receiver to the antenna 112 in time duplex fashion. The operations of the transceivers 110, 130a, and 130b are coordinated in time such that the uplink receiver is coupled to the antenna 132a and 132b for reception of transmissions over the wireless communication channels 155 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channels 155. The wireless communication channel 155 can be any wireless channel or other medium suitable for downlink (DL) and/or uplink (UL) transmission of data as described herein.

The UE transceiver 130a/130b and the BS transceiver 110 are configured to communicate via the wireless data communication channel 155, and cooperate with a suitably configured antenna arrangement that can support a particular wireless communication protocol and modulation scheme. In some arrangements, the UE transceiver 130a/130b and the BS transceiver 110 are configured to support industry standards such as the Long Term Evolution (LTE) and emerging 5G standards, or the like. It is understood, however, that the present disclosure is not necessarily limited in application to a particular standard and associated protocols. Rather, the UE transceiver 130a/130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods or algorithms described in connection with the arrangements disclosed herein may be embodied directly in hardware, in firmware, in a software module executed by processor modules 114, 136a, and 136b, respectively, or in any practical combination thereof. The memory modules 116, 134a, 134b can be realized as RAM memory, flash memory, ROM memory, EPROM memory, EEPROM memory, registers, a hard disk, a removable disk, a CD-ROM, or another suitable form of storage medium. In this regard, the memory modules 116, 134a, and 134b may be coupled to the processor modules 114, 136a, and 136b, respectively, such that the processors modules 114, 136a, and 136b can read information from, and write information to, the memory modules 116, 134a, and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 114, 136a, and 136b, respectively. Memory modules 116, 134a, and 134b may also each include non-volatile memory for storing instructions to be executed by the processor modules 114, 136a, and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

The BS 102 can communicate with a plurality of UEs (including the UEs 104a and 104b) using multicast or broadcast, collectively referred to as MBS. The plurality of UEs can each receive MBS channel (e.g., MBS PDSCH, MBS PDCCH, and so on) via multicast and/or broadcast. In order to receive the MBS channel, the plurality of UEs have a common understanding on the configurations of the MBS channel, including but not limited to, frequency resource range for resource allocation, scrambling sequence, and so on.

More specifically, R17 MBS restricts the multicast transmission from using the same numerology as the unicast. Therefore, the Common Frequency Domain (CFR) within the dedicated unicast Bandwidth Part (BWP) of a UE is defined for the MBS transmission to allow unicast and multicast to be received simultaneously. In this case, the Physical Downlink Control Channel (PDCCH) and Physical Downlink Shared Channel (PDSCH) for the MBS are configured independently from that of the unicast, while the MBS BWP and the 4 unicast BWP share the Sub-Carrier Spacing (SCS)/Cyclic Prefix (CP) parameters. For R18, System Frame Number (SFN)-based MBS transmissions are supported. Therefore, regardless of whether a new SCS is introduced for the MBS transmission or defined as Extended Cyclic Prefix (ECP) (e.g., 15 kHz ECP), the SCS of SFN-based MBS transmission may be less than that of the unicast. For example, the SCS for unicast is 30 kHz while the SCS for MBS is 15 kHz. Then, the configuration of the numerology (including, SCS, CP type, etc) cannot be shared any more. In addition, given that the data transmission in the BWP can be configured with only the same SCS and CP, CFR is no longer applicable for MBS transmissions with SCS/CP that is different with that for the unicast.

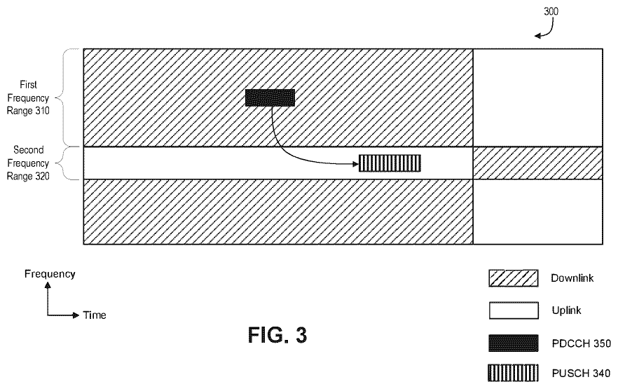

In another example scenario, flexible duplex or full duplex is proposed to reduce the uplink and downlink conversion delay. In this scenario, UEs receive and transmit signals simultaneously or switch between reception and transmission without delay. FIG. 3 is a diagram illustrating the manner in which different frequency ranges (e.g., first frequency range 310 and second frequency range 320) within a carrier 300 are configured with different downlink uplink frame structures, according to various arrangements. Referring to FIGS. 1-3, the frequency range 310 and the frequency range 320 are configured with a complementary structure. For example, downlink resource in the time domain for the first frequency range 310 corresponds to uplink resource in the time domain for the second frequency range 320, and uplink resource in time domain for the first frequency range 310 corresponds to downlink resource in the time domain for the second frequency range 320. In scheduling an uplink transmission (e.g., a PUSCH 340) using PDCCH 350, the base station can select any uplink slot in either the first frequency range 310 or the second frequency range 320 for the PUSCH 340 . This allows the uplink scheduling delay to be saved, and the UE can operate in both frequency ranges simultaneously.

In the multi-bands-single-cell scenario, a cell is defined as a set of frequency resources that span multiple bands/carriers. Transmissions on different bands/carriers within one cell can be performed at the same time. A total number of transmissions that can be received or transmitted simultaneously by a UE is the UE capability of the UE. If the UE can support reception or transmission on multiple bands/carriers, no switching is needed. On the other hand, if the UE can support only one band, dynamically switching among different bands/carriers within a cell is used.

In such scenarios, multiple services need to be transmitted in parallel in the same cell or carrier. The present arrangements relate to coordinating and configuring these concurrent services.

Due to factors such as terminal cost, power consumption, and cell coverage, the base station can configure multiple sets of BWPs for UE on one carrier. For example, at most four sets of BWPs can be configured for a UE per cell. At the same time, the UE in an existing system activates only one set of BWPs and uses this set for data reception and transmission. Each set of BWPs includes at least one of an uplink BWP and a downlink BWP. That is, the BWPs allocated by the base station to the UE can be paired. If the downlink BWP resource of a UE is released or deactivated by the base station, the uplink BWP corresponding to the downlink BWP is also released or deactivated.

In some scenarios, if multiple concurrent transmissions are limited to one activated BWP, service transmission is greatly restricted. If different transmissions are configured in different BWPs, switching between different service transmissions is implemented through BWP switching, which introduces 1˜3 ms switching delay. Frequent switching is unacceptable as it degrades user experience. Various arrangements to allow multiple BWPs to be activated simultaneously.

As referred to herein, a BWP is used as a general example of a frequency resource of a cell. It should be noted that other forms of frequency resources of a cell, e.g., subband, Common Frequency Resource (CFR), frequency band, etc., can be similarly implemented.

In some arrangements, multiple frequency resources which can be activated simultaneously are configured.

In some examples, a list of BWPs are configured for a given cell by a base station associated with the cell. The configuration parameters of each BWP include at least one of BWP index within a cell, numerology, frequency position and bandwidth, PDCCH reception/monitoring configuration (e.g., search space set, CORESET, etc), PDSCH reception configuration (e.g., TDRA table, etc), SPS configuration, and so on. The BWP index is numbered within the scope of a given cell and can be referred to as a first BWP index. In other words, the first BWP index distinguishes the BWPs within the same cell.

In some examples, the UE can simultaneously activate any combination of BWPs as long as the total number of activated BWPs does not exceed a maximum number of active BWPs supported by the UE.

In some examples, the UE simultaneously activate the BWPs that meets one or more predefined conditions. The predefined conditions can include one or more of BWPs with the same numerology, BWPs with a specific frequency domain location (e.g., one BWP contains another BWP in frequency domain, etc.), and so on. For example, in response to determining that two or more BWPs have the same numerology, the UE activates the two or more BWPs to be used simultaneously in communication with the base station. In another example, in response to determining that a first BWP contains a second BWP in the frequency domain, the UE activates the first and second BWPs to be used simultaneously in communication with the base station. The UE determines whether two or more BWPs meet at least one of the predefined conditions. If yes, the UE can activate the two or more BWPs at the same time. Accordingly, in some arrangements, communicating using the two or more frequency resources simultaneously includes activating, by the UE, the two or more frequency resources in response to determining that the two or more frequency resources meet at least one condition.

In some examples, the base station configures one or more BWP sets or groups for a UE. Each BWP set is identified by a corresponding BWP set index. The UE can simultaneously activate any combination of the BWPs within each BWP set.

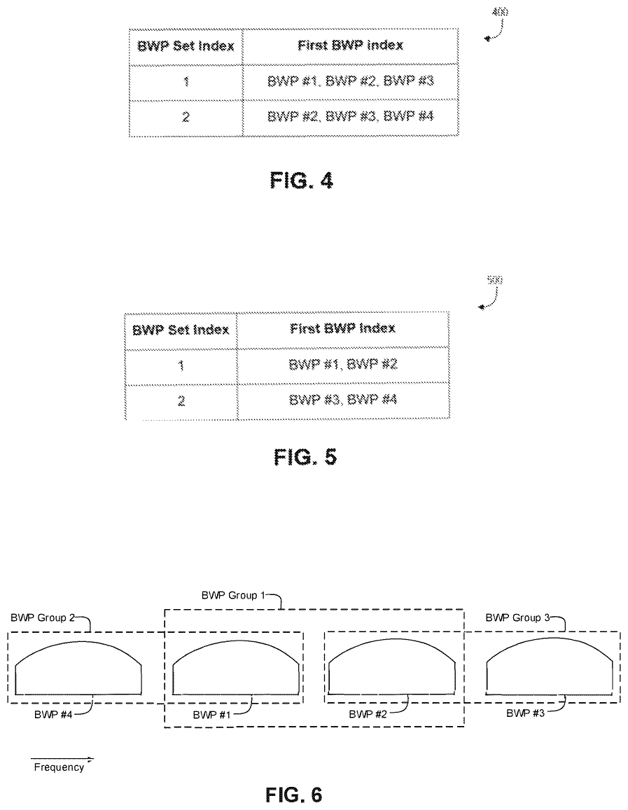

FIG. 4 is a table 400 illustrating an example of configured relationships between BWP sets and BWPs of a cell, according to various arrangements. As shown in the table 400, the base station of the cell defines and configures four BWPs with BWP indices (first BWP indices) #1-#4 for the cell. The base station also defines and configures two BWP sets or groups with BWP group indices 1 and 2. As shown in table 400, BWP set 1 includes BWPs with first BWP indices #1, #2, and #3, and BWP set 2 includes BWPs with first BWP indices #2, #3, and #4. According to BWP set configuration, different BWP combinations that can be activated simultaneously at the same time can be identified. For example, the base station can send the BWP set configuration (e.g., the BWP set index for each of the at least one configured BWP set) to the UE using suitable signaling such as Radio Resource Control (RRC) signaling or another suitable type of signaling. In one example in which at most two BWPs can be activated simultaneously, the BWPs in each of the following combinations with two BWPs can be activated simultaneously: {BWP1, BWP2}; {BWP1, BWP3}; {BWP2, BWP3}; {BWP2, BWP4}; {BWP2, BWP3}; and {BWP3, BWP4}.

In some arrangements, the base station can indicate to the UE the BWP combination that to be activated via suitable signaling such as Media Access Control (MAC) signaling or Downlink Control Information (DCI) format.

In some examples, the base station determines all combinations of BWPs which may include for example {BWP1, BWP2}; {BWP1, BWP3}; {BWP2, BWP3}; {BWP2, BWP4}; {BWP3, BWP4}.

In some examples, the base station configures two or more BWP sets for a UE. The UE activates only one BWP in a BWP set at any given time, and a BWP from two or more different BWP sets can be activated simultaneously. FIG. 5 is a table 500 illustrating an example of configured relationships between BWP sets and BWPs of a cell according to various arrangements. As shown in the table 500, the base station of the cell defines and configures four BWPs with BWP indices (first BWP indices) #1-#4 for the cell. The base station also defines and configures two BWP sets or groups with BWP group indices 1 and 2. As shown in table 500, BWP set 1 includes BWPs with first BWP indices #1 and #2, and BWP set 2 includes BWPs with first BWP indices #3 and #4. The base station can signal or indicate to the UE and the UE activates one BWP from BWP set 1 and another BWP from BWP set 2 at the same time. For example, the following combinations of BWPs can be simultaneously activated by the UE: {BWP1, BWP3}; {BWP1, BWP4}; {BWP2, BWP3}; and {BWP2, BWP4}.

Accordingly, multiple BWPs can be configured to be activated at the same time effectively, which provides the base condition for enabling multiple BWPs to be activated at the same time.

Some arrangements relate to dynamic operations among different BWPs.

Various mechanism can be implemented for dynamic operations among different BWPs.

FIG. 6 is a diagram illustrating an example of configured relationships between BWP sets and BWPs of a cell according to various arrangements. As shown in FIG. 6, the base station of the cell defines and configures four BWPs with BWP indices (first BWP indices) #1-#4 for the cell. The base station also defines and configures three BWP sets or groups with BWP group indices 1, 2, and 3 As shown in FIG. 6, BWP group 1 includes BWPs with first BWP indices #1 and #2. BWP group 2 includes BWPs with first BWP indices #1 and #4. BWP group 3 includes BWPs with first BWP indices #2 and #3. In some arrangements, the BWPs the following BWP combinations can be activated simultaneously: {BWP1, BWP2}, {BWP2, BWP3}, and {BWP1, BWP4}.

The downlink or uplink scheduling DCI contains a BWP indicator field, which is used for indicating the scheduled BWP for data transmitting. In some arrangements, the BWP indicator field includes a value corresponding to an index (e.g., the first BWP index) of the scheduled BWP. The BWP used for transmitting the DCI can be referred to as scheduling BWP. The BWP indicated by the DCI for data transmitting can be referred to as scheduled BWP. The various operations related to BWP switching, BWP activation, or BWP deactivation can be implemented.

In some arrangements, the scheduled BWP is activated after scheduling (e.g., after receiving the downlink or uplink scheduling DCI). In some examples, the base station sends, to the UE on the scheduling BWP, the downlink scheduling DCI containing the BWP indicator field having a value corresponding to an index (e.g., the first BWP index) of the scheduled BWP. In response to receiving the downlink scheduling DCI scheduling downlink data, the UE activates the scheduled BWP on which the scheduled data is to be received by the UE. In some examples, the base station sends, to the UE on the scheduling BWP, the uplink scheduling DCI containing the BWP indicator field having a value corresponding to an index (e.g., the first BWP index) of the scheduled BWP. In response to receiving the uplink scheduling DCI scheduling uplink data, the UE activates the scheduled BWP on which the scheduled data is to be transmitted to the base station by the UE.

In some arrangements, the UE determines whether to keep the scheduling BWP activated after receiving the scheduling DCI, after receiving downlink data scheduled by the scheduling DCI, or after sending uplink data scheduled by the scheduling DCI according to at least one of whether the BWP can be activated together with the scheduled BWP simultaneously, the UE capability on the upper limit of number of active BWPs that can be activated simultaneously, the number of BWPs currently activated by the UE, and the activation status of the scheduled BWP.

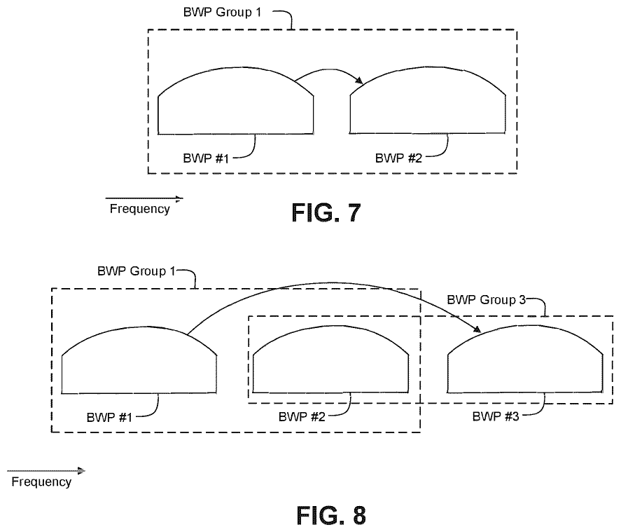

FIG. 7 is a diagram illustrating an example of configured relationships between BWP groups and BWPs of a cell according to various arrangements. As shown in FIG. 7, in response to determining that a number of activated BWPs does not exceed the upper limit (the maximum number) of UE capability, the DCI sent in the scheduling BWP (e.g., BWP #1) indicates the scheduled BWP (e.g., BWP #2) which can be activated at the same time. The scheduled BWP #2 is not activated before the scheduling (e.g., before receiving the scheduling BWP #1. In this case, the UE activates BWP #2. The UE does not deactivate the scheduling BWP #1 after activating the scheduled BWP #2. Accordingly, in response to receiving the DCI on the scheduling BWP #1, both of scheduling BWP #1 and scheduled BWP #2 are activated simultaneously. In that regard, BWP #1 and BWP #2 are in a same BWP group (e.g., BWP group 1).

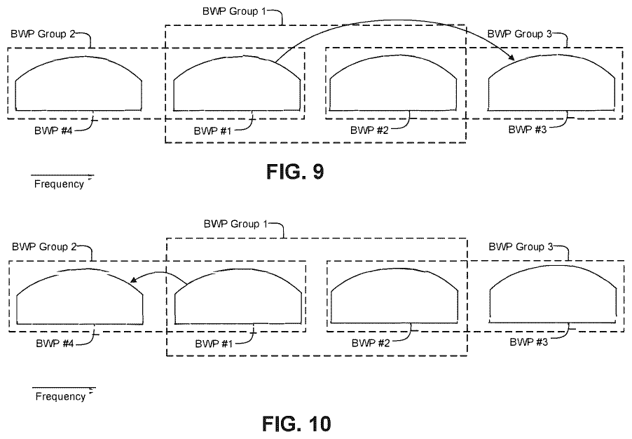

FIG. 8 is a diagram illustrating an example of configured relationships between BWP sets and BWPs of a cell according to various arrangements. FIG. 9 is a diagram illustrating an example of configured relationships between BWP sets and BWPs of a cell according to various arrangements. As shown in FIGS. 8 and 9, the DCI sent in the scheduling BWP (i.e., BWP #1) indicates another scheduled BWP (i.e., BWP #3), which cannot be activated at the same time as the scheduling BWP. In this case, regardless of whether the number of activated BWPs exceeds the upper limit of UE capability, the UE switches BWP from the scheduling BWP #1 to scheduled BWP #3. That is, the UE activates the scheduled BWP #3 in response to receiving the DCI on the scheduling BWP #1. In addition, the UE deactivates BWP #1 in response to receiving the DCI on the scheduling BWP #1.

For other BWP(s) (e.g., BWP #2 in FIG. 8 or BWP #4 in FIG. 9) originally activated together with scheduling BWP, there are two cases as follows:

In some arrangements as shown in FIG. 8, initially, BWP group 1 which includes BWP #1 and BWP #2 that are activated simultaneously. In response to determining that the other BWP (e.g., BWP #2) and the scheduled BWP (e.g., BWP #3) can be activated simultaneously, the UE keeps the other BWP (e.g., BWP2) activated. In other words, after the scheduling (e.g., after receiving the DCI on the scheduling BWP #1), both of other BWP #2 and the scheduled BWP #3 are activated. In this case, transmission on BWP #2 is not impacted by the BWP switching from BWP #1 to BWP #3.

In some arrangements as shown in FIG. 9, initially, BWP group 2 includes BWP #1 and BWP #4 that are activated simultaneously. The other BWP (e.g., BWP #4) and the scheduled BWP (e.g., BWP #3) cannot be activated simultaneously. Therefore, the other BWP (#4 is deactivated. Therefore, after the scheduling (e.g., after receiving the DCI on the scheduling BWP #1), only the scheduled BWP #3 is activated. Both of BWP #1 and BWP #4 will be deactivated.

FIG. 10 is a diagram illustrating an example of configured relationships between BWP sets and BWPs of a cell according to various arrangements. As shown in FIG. 10, the currently active BWP group is BWP group 1, which includes BWP #1 and BWP #2. The DCI sent by the base station on scheduling BWP (e.g., BWP #1) indicates a scheduled BWP (e.g., BWP #4) that can be activated simultaneously. After the receiving the scheduling DCI, the scheduled BWP #4 will be activated. Given that BWP #2, which was originally activated with scheduling BWP #1 simultaneously, cannot be activated simultaneously with scheduled BWP #4. Therefore, the UE deactivates BWP #2. In addition, the UE keeps the scheduling BWP #1 activated.

In this case, the DCI transmitted on one BWP (e.g., BWP #1) triggers the switching between the other two BWPs, that is, switching from BWP #2 to BWP #4.

In some examples, the transmission on BWP #1 is not impacted by the BWP switching from BWP #2 to BWP #4.

In some arrangements, a DCI transmitted on an active BWP indicates the same active BWP for data scheduling, e.g., BWP indicator field indicates the first BWP index of the current activated BWP carrying the DCI. The data will be transmitted on the same active BWP, and transmission on other active BWP(s) will not be impact by the scheduling.

In some arrangements, a DCI transmitted on an active BWP (scheduling BWP) indicates another active BWP for data scheduling, e.g., BWP indicator field indicates the first BWP index of another currently activated BWP. The data will be transmitted on the scheduled BWP, and transmission on the active BWP(s) (scheduling BWP) will not be impact by the scheduling.

Accordingly, dynamic switching of multiple BWPs can be achieved. At the same time, the data scheduling indication in case of BWP group switching is supported.

Some arrangements relate to RRC-based switching between different BWP groups.

For RRC-based switching, in some examples, a list of a first active BWP (including at least one of a first active downlink BWP and a first active uplink BWP) can be configured by base station. The configuration information contains a list of indices (e.g., first BWP indices) of the BWP(s) to be activated upon performing the RRC configuration or reconfiguration. If the configuration information is absent, the RRC configuration or reconfiguration does not impose a BWP group switching.

More specifically, the following signaling structure can be used for the configuration of the first active BWP list. The parameter of ‘maxNrofActivedBWPs’ represents the upper limit of number of BWPs that can be activated simultaneously by a UE. According to the structure, at most ‘maxNrofActivedBWPs’ BWP indices can be configured for a UE for downlink and uplink, respectively. That is:
firstActiveDownlinkBWP-Id SEQUENCE (SIZE (1.. maxNrofActivedBWPs)) OF BWP-Id;
firstActiveUplinkBWP-Id SEQUENCE (SIZE (1.. maxNrofActivedBWPs)) OF BWP-Id.

Accordingly, the RRC-based semi-static switching operation basing on first active BWP list is defined, thus achieving the RRC-based semi-static switching of multiple BWPs.

Some arrangements relate to timer-based switching between different BWP groups.

For timer-based BWP group switching, in some examples, a default downlink BWP group (including at least one of a default downlink BWP) can be configured by base station for a UE. The configuration information contains the first BWP indices of BWPs in the default downlink BWP group. If the configuration information is absent, the BWP group including an initial BWP will be the default downlink BWP group.

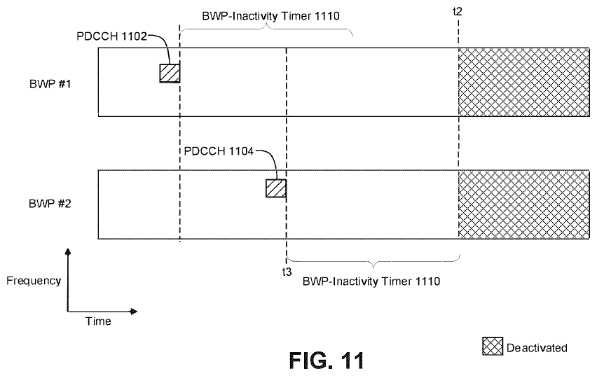

FIG. 11 is a diagram illustrating timer-based BWP group switching, according to various arrangements. In FIG. 11, the horizontal axis corresponds to time, and the vertical axis corresponds to frequency. In some examples, one BWP group inactivity timer (e.g., BWP-Inactivity Timer 1110) will also be configured by the base station for a BWP group. The BWP group inactivity timer is reset by the UE in response to the UE detecting a PDCCH or receive a MAC PDU in a configured downlink assignment on any BWP that belongs to the currently active BWP group. In other words, the timer applies to all BWPs in the BWP group. In FIG. 11, for example, the currently active BWP group (e.g., the BWP Group 1) includes BWP #1 and BWP #2. In response to the UE detecting the PDCCH 1102 on BWP #1, the BWP group inactivity timer (e.g., the BWP-Inactivity Timer 1110) is restarted following the end of the PDCCH 1102 in the time domain. Before the expiration of the BWP-Inactivity Timer 1110, the UE detects another PDCCH 1104 on BWP #2. In response to the UE detecting the PDCCH 1104, the BWP group inactivity timer (e.g., the BWP-Inactivity Timer 1110) is restarted following the end of the PDCCH 1104 at t3 in the time domain. The UE switches the active BWP group to a default BWP group when the BWP-Inactivity Timer 1110 expires at t2. In other words, the timer is reset at t3 according to PDCCH reception on BWP #2. The UE switches from BWP Group 1 (including BWP #1 and BWP #2) to a default BWP of a default BWP group at t2, as there is no related reception on both of BWP #1 and BWP #2 for a duration of BWP-Inactivity Timer 1110. The BWP Group 1 is deactivated after t2.

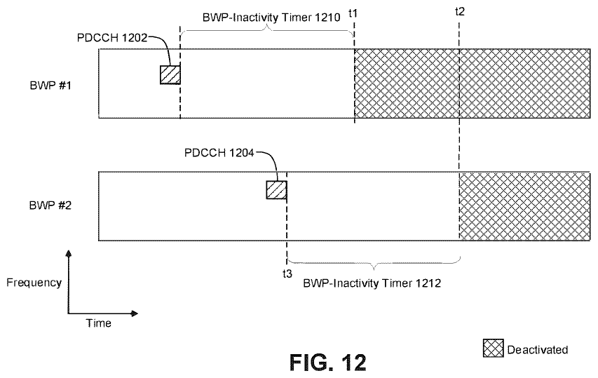

FIG. 12 is a diagram illustrating timer-based BWP group switching, according to various arrangements. In FIG. 12, the horizontal axis corresponds to time, and the vertical axis corresponds to frequency. In some arrangements, the base station configures two or more BWP inactivity timers for an active BWP group. For example, a timer is defined for each BWP in a BWP group. For a BWP, its timer will be reset if a UE detects a PDCCH or receive a MAC PDU in a configured downlink assignment on this BWP. In FIG. 12, for example, the currently active BWP group (e.g., the BWP Group 1) includes BWP #1 and BWP #2. In response to the UE detecting the PDCCH 1202 on BWP #1, the BWP inactivity timer (e.g., the BWP-Inactivity Timer 1210) is restarted following the end of the PDCCH 1202 in the time domain. In response to the UE detecting the PDCCH 1204 on BWP #2, the BWP inactivity timer (e.g., the BWP-Inactivity Timer 1212) is restarted following the end of the PDCCH 1204 in the time domain. The timers 1210 and 1212 may correspond to the same time interval or different time intervals.

The UE switches from the active BWP group to a default BWP (of a default BWP group) in response to determining that the timers for all of the BWPs within the active BWP group are expired. As an example shown in FIG. 12, the UE deactivates BWP #1 starting from t1 as the timer of BWP1 is expired at t1. The timer of BWP2 expires at t2. Assuming that the BWP group includes only BWPs #1 and #2 all of the timers of BWPs are expired at t2. The UE switches the active BWP to a default BWP at t2.

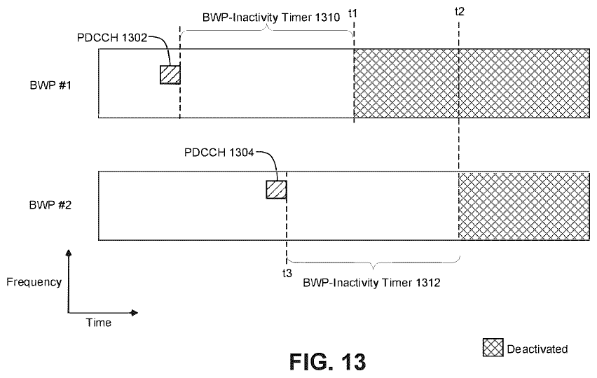

FIG. 13 is a diagram illustrating timer-based BWP group switching, according to various arrangements. In FIG. 13, the horizontal axis corresponds to time, and the vertical axis corresponds to frequency. In some arrangements, the base station configures two or more BWP inactivity timers for the active BWP group. For example, a timer is defined for each BWP in a BWP group. For a BWP, the UE resets the timer of the BWP in response to detecting a PDCCH or receive a MAC PDU in a configured downlink assignment on this BWP.

In FIG. 13, for example, the currently active BWP group (e.g., the BWP Group 1) includes BWP #1 and BWP #2. In response to the UE detecting the PDCCH 1302 on BWP #1, the BWP inactivity timer (e.g., the BWP-Inactivity Timer 1310) is restarted following the end of the PDCCH 1302 in the time domain. In response to the UE detecting the PDCCH 1304 on BWP #2, the BWP inactivity timer (e.g., the BWP-Inactivity Timer 1312) is restarted following the end of the PDCCH 1304 in the time domain. The timers 1310 and 1312 may correspond to the same time interval or different time intervals.

The UE switches from a BWP of the activate BWP group to a default BWP (of a default BWP group) in response to determining that the a timer for a BWP of the active BWP group is expired. In other words, if the timer of a BWP expires, that BWP is deactivated and the default BWP is activated. As an example shown in FIG. 13, the UE deactivates BWP #1 and switches to a default BWP at t1 as the timer 1310 of BWP #1 expires at t1. The timer 1312 of BWP #2 expires at t2, therefore, the UE deactivates BWP #2 at t2.

With the above method, the timer-based semi-static switching operation in the unit of BWP group is defined, thus achieving the timer-based semi-static switching of multiple BWPs.

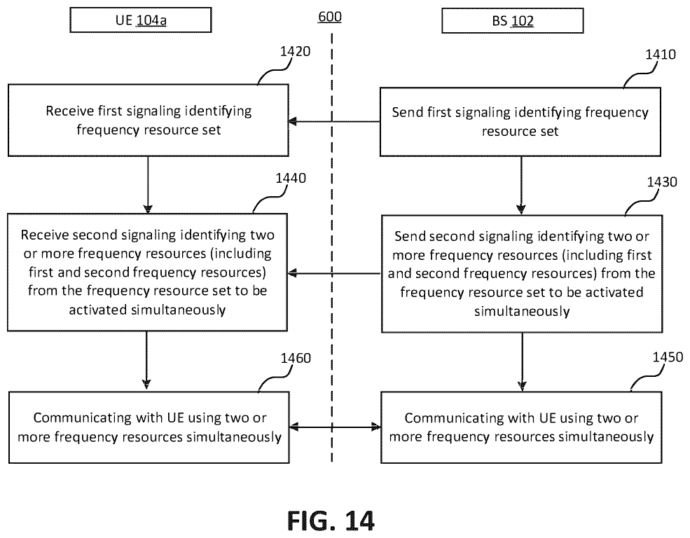

FIG. 14 is a flowchart diagram illustrating an example method 1400 for managing frequency resource group based service transmissions, according to various arrangements. The method 1400 can be performed by the UE 104a and the network (e.g., the BS 102).

At 1410, the network (e.g., the BS 102) sends to the UE 104a first signaling identifying a frequency resource set. At 1420, the UE 104a receives from the BS 102 the first signaling that identifies the frequency resource set. In some examples, the first signaling includes RRC signaling. In some arrangements, the frequency resource set comprises a BWP set.

At 1430, the network (e.g., the BS 102) sends to the UE 104a second signaling identifying two or more frequency resources from the frequency resource set to be activated simultaneously. The two or more frequency resources includes a first frequency resource and a second frequency resource. At 1440, the UE 104a receives from the BS 102 the second signaling that identifies two or more frequency resources from the frequency resource set to be activated simultaneously. In some examples, the second signaling includes MAC signaling, RRC signaling, any type of physical layer signaling, or so on. In some examples, each of the two or more frequency resources is a BWP.

At 1450 and 1460, the BS 102 and the UE 104a communicate with each other using the two or more frequency resources simultaneously, in response to sending or receiving the second signaling.

In some arrangements, communicating using the two or more frequency resources simultaneously includes activating, by the UE 104a, the two or more frequency resources in response to determining that the two or more frequency resources meet at least one condition. As described herein, the predefined conditions can include one or more of BWPs with the same numerology, BWPs with a specific frequency domain location (e.g., one BWP contains another BWP in frequency domain, etc.), and so on.

In some arrangements, the frequency resource set includes a first frequency resource set and a second frequency resource set. The first frequency resource is from the first frequency resource set, and the second frequency resource is from the second frequency resource set.

In some arrangements, the network (e.g., the BS 102) sends and the UE 104a receives scheduling indication on the first frequency resource. The scheduling indication schedules downlink data to be received by the UE 104a from the network using a third frequency resource or uplink data to be transmitted by the UE 104a to the network using the third frequency resource. The UE 104a determines to activate the third frequency resource in response to receiving the scheduling indication on the first frequency resource. The scheduling indication includes one or more of uplink DCI or downlink DCI.

In some arrangements, the UE 104a determines to keep the first frequency resource activated in response to receiving the scheduling indication on the first frequency resource based on at least one of whether the first frequency resource can be activated with the third frequency resource simultaneously, a maximum number of frequency resources that can be activated simultaneously according to capability of the wireless communication device, a number of frequency resources that are currently activated by the wireless communication device, or an activation status of the third frequency resource.

In some arrangements, the method 1400 further includes sending, by the BS 102 to the UE 104a, an frequency resource list including at least one frequency resource. The UE 104a receives from the BS 102 the frequency resource list. The UE 104a switches to the at least one frequency resource in response to RRC configuration or reconfiguration.

In some arrangements, the UE 104a determines that no downlink transmission (e.g., PDCCH or PDU) has been received within a time interval corresponding to an inactivity timer on any frequency resource in the frequency resource set since receiving a previous downlink transmission on a frequency resource in the frequency resource set. In response, the UE 104a switches to the at least one default frequency resource from the frequency resource set.

In some arrangements, the UE 104a determines that no downlink transmission (e.g., PDCCH or PDU) has been received within a time interval corresponding to a first inactivity timer on the first frequency resource in the frequency resource set since receiving a previous downlink transmission on the first frequency resource in the frequency resource set. In response, the UE 104 deactivates the first frequency resource.

In some arrangements, the UE 104a further determines that no downlink transmission (e.g., PDCCH or PDU) has been received within a time interval corresponding to a second inactivity timer on a second frequency resource in the frequency resource set since receiving a previous downlink transmission on the second frequency resource. In the arrangements in which the frequency resource set includes only the first and second frequency resources which are simultaneously activated, the UE 104a switching to the at least one default frequency resource from the frequency resource set in response to determining that no downlink transmission has been received within the time interval corresponding to the first inactivity timer on the first frequency resource since receiving the previous downlink transmission on the first frequency resource and no downlink transmission has been received within the time interval corresponding to the inactivity timer on the second frequency resources in the frequency resource set since receiving the previous downlink transmission on the second frequency resource. For frequency resource sets with three or more frequency resources, switching to the default frequency resource after or in response to all timers for all resources expire before. For the timer that is not the last timer in the frequency resource set to expire, the corresponding frequency resource is deactivated.

In some arrangements, the UE 104a determines that no downlink transmission (e.g., PDCCH or PDU) has been received within a time interval corresponding to a first inactivity timer on the first frequency resource in the frequency resource set since receiving a previous downlink transmission on the first frequency resource in the frequency resource set. In response, the UE 104 switches to the at least one default frequency resource from the first frequency resource.

In some arrangements in which the frequency resource set includes only the first and second frequency resources in which the frequency resource set includes only the first and second frequency resources which are simultaneously activated, the UE 104a further determines that no downlink transmission (e.g., PDCCH or PDU) has been received within a time interval corresponding to a second inactivity timer on a second frequency resource in the frequency resource set since receiving a previous downlink transmission on the second frequency resource. In response, the UE 104a deactivates the second frequency resource. For frequency resource sets with three or more frequency resources, switching to the default frequency resource occurs in response to the timer for each resource in the frequency resource set expires. In response to determining that the last timer in the frequency resource set expires, the corresponding frequency resource is deactivated.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It is understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is further understood by those within the art that if a specific number of an introduced claim recitation is intended, such an intent is explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to the disclosure containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It is further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” is understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the disclosure be defined by the claims appended hereto and their equivalents.

1. A wireless communication method, comprising:
receiving, by a wireless communication device from a network, first signaling identifying a frequency resource set;
receiving, by the wireless communication device from the network, second signaling identifying two or more frequency resources from the frequency resource set to be activated simultaneously, wherein the two or more frequency resources comprises a first frequency resource and a second frequency resource; and
in response to receiving the second signaling, communicating, by the wireless communication device with the network using the two or more frequency resources simultaneously.

2. The method of claim 1, wherein the frequency resource set comprises a Bandwidth Part (BWP) set; and each of the two or more frequency resources is a BWP.

3. The method of claim 1, wherein communicating using the two or more frequency resources simultaneously comprises activating, by the wireless communication device, the two or more frequency resources in response to determining that the two or more frequency resources meet at least one condition.

4. The method of claim 1, wherein
the frequency resource set comprises a first frequency resource set and a second frequency resource set; and
the first frequency resource is from the first frequency resource set, and the second frequency resource is from the second frequency resource set.

5. The method of claim 1, further comprising:
receiving, by the wireless communication device from the network, scheduling indication on the first frequency resource, the scheduling indication schedules downlink data to be received by the wireless communication device from the network using a third frequency resource or uplink data to be transmitted by the wireless communication device to the network using the third frequency resource;
determining, by the wireless communication device, to activate the third frequency resource in response to receiving the scheduling indication on the first frequency resource.

6. The method of claim 5, determining, by the wireless communication device, to keep the first frequency resource activated in response to receiving the scheduling indication on the first frequency resource based on at least one of:
whether the first frequency resource can be activated with the third frequency resource simultaneously;
a maximum number of frequency resources that can be activated simultaneously according to capability of the wireless communication device;
a number of frequency resources that are currently activated by the wireless communication device; or
an activation status of the third frequency resource.

7. The method of claim 1, further comprising:
receiving, by the wireless communication device from the network, a frequency resource list comprising at least one frequency resource; and
switching, by the wireless communication device, to the at least one frequency resource in response to Radio Resource Control (RRC) configuration or reconfiguration.

8. The method of claim 1, further comprising:
determining, by the wireless communication device, that no downlink transmission has been received within a time interval corresponding to an inactivity timer on any frequency resource in the frequency resource set since receiving a previous downlink transmission on a frequency resource in the frequency resource set; and
switching, by the wireless communication device, to at least one default frequency resource from the frequency resource set in response to determining that no downlink transmission has been received within the time interval corresponding to the inactivity timer on any frequency resource in the frequency resource set since receiving the previous downlink transmission on the frequency resource in the frequency resource set.

9. The method of claim 1, further comprising:
determining, by the wireless communication device, that no downlink transmission has been received within a time interval corresponding to a first inactivity timer on the first frequency resource in the frequency resource set since receiving a previous downlink transmission on the first frequency resource in the frequency resource set; and
deactivating, by the wireless communication device, the first frequency resource in response to determining that no downlink transmission has been received within the time interval corresponding to the first inactivity timer on the first frequency resource since receiving the previous downlink transmission on the first frequency resource.

10. The method of claim 9, further comprising:
determining, by the wireless communication device, that no downlink transmission has been received within a time interval corresponding to a second inactivity timer on a second frequency resource in the frequency resource set since receiving a previous downlink transmission on the second frequency resource; and
switching, by the wireless communication device, to at least one default frequency resource from the frequency resource set in response to determining that no downlink transmission has been received within the time interval corresponding to the first inactivity timer on the first frequency resource since receiving the previous downlink transmission on the first frequency resource and no downlink transmission has been received within the time interval corresponding to the inactivity timer on the second frequency resources in the frequency resource set since receiving the previous downlink transmission on the second frequency resource.

11. The method of claim 1, further comprising:
determining, by the wireless communication device, that no downlink transmission has been received within a time interval corresponding to a first inactivity timer on a first frequency resource in the frequency resource set since receiving a previous downlink transmission on the first frequency resource; and
switching, by the wireless communication device, to at least one default frequency resource from the first frequency resource in response to determining that no downlink transmission has been received within the time interval corresponding to the first inactivity timer on the first frequency resource since receiving the previous downlink transmission on the first frequency resource.

12. The method of claim 11, further comprising:
determining, by the wireless communication device, that no downlink transmission has been received within a time interval corresponding to a second inactivity timer on a second frequency resource in the frequency resource set since receiving a previous downlink transmission on the second frequency resource; and
deactivating, by the wireless communication device, the second frequency resource in response to determining that no downlink transmission has been received within the time interval corresponding to the second inactivity timer on the second frequency resource since receiving the previous downlink transmission on the second frequency resource.

13. A wireless communication apparatus comprising at least one processor and a memory, wherein the at least one processor is configured to read code from the memory and implement the method recited in claim 1.

14. A computer program product comprising a computer-readable program medium code stored thereupon, the code, when executed by at least one processor, causing the at least one processor to implement the method recited in claim 1.

15. A wireless communication method, comprising:
sending, by a network to a wireless communication device, first signaling identifying a frequency resource set;
sending, by the network to the wireless communication device, second signaling identifying two or more frequency resources from the frequency resource set to be activated simultaneously, wherein the two or more frequency resources comprises a first frequency resource and a second frequency resource; and
in response to sending the second signaling, communicating, by the network with the wireless communication device using the two or more frequency resources simultaneously.

16. The method of claim 15, wherein
the frequency resource set comprises a Bandwidth Part (BWP) set; and
each of the two or more frequency resources is a BWP.

17. The method of claim 15, wherein the wireless communication device activates the two or more frequency resources in response to determining that the two or more frequency resources meet at least one condition.

18. The method of claim 15, wherein
the frequency resource set comprises a first frequency resource set and a second frequency resource set; and
the first frequency resource is from the first frequency resource set, and the second frequency resource is from the second frequency resource set.

19. The method of claim 15, further comprising sending, by the network to the wireless communication device, scheduling indication on the first frequency resource, the scheduling indication schedules downlink data to be received by the wireless communication device from the network using a third frequency resource or uplink data to be transmitted by the wireless communication device to the network using the third frequency resource, wherein the wireless communication device determines to activate the third frequency resource in response to receiving the scheduling indication on the first frequency resource.

20. The method of claim 15, further comprising sending, by the network to the wireless communication device, a frequency resource list comprising at least one frequency resource, wherein the wireless communication device switches to the at least one frequency resource in response to Radio Resource Control (RRC) configuration or reconfiguration.

21. A wireless communication apparatus comprising at least one processor and a memory, wherein the at least one processor is configured to read code from the memory and implement the method recited in claim 15.

22. A computer program product comprising a computer-readable program medium code stored thereupon, the code, when executed by at least one processor, causing the at least one processor to implement the method recited in claim 15.
